(19) United States
(12) Patent Application Publication
(10) Pub. No.: US 2013/0166802 A1
(43) Pub. Date: Jun. 27, 2013

(54) TRANSPONDER, METHOD AND RECORDING MEDIUM CONTAINING INSTRUCTIONS FOR CONTROLLING THE SAME

(71) Applicant: NEC CORPORATION, Tokyo (JP)

(72) Inventor: Koji SEKI, Tokyo (JP)

(73) Assignee: NEC CORPORATION, Tokyo (JP)

(21) Appl. No.: 13/724,936

(22) Filed: Dec. 21, 2012

(30) Foreign Application Priority Data
Dec. 26, 2011 (JP) 2011-283748

(51) Int. Cl. G06F 13/364

(52) U.S. Cl. CPC G06F 13/364
USPC 710/110

(57) ABSTRACT

A transponder connected to a master, a transmission module and a reception module, the transponder including: a memory which stores a table indicating whether or not a command from the master is executable, wherein the table including: type information indicating a type of the command; and first status information including at least one of: a transmission status indicating a communication status of the transmission module; and a reception status indicating a communication status of the reception module; an acquiring unit that acquires second status information including at least one of: a current transmission status indicating a current communication status of the transmission module; and a current reception status indicating a current communication status of the reception module; a judging unit that judges, in response to a received command received from the master, whether or not the received command is executable using the table and the second status information.

### BACKGROUND

An illustrative embodiment relates to a transponder used in an optical network and the like, and particularly relates to judgment on and notification of whether or not a command is executable in I2C (Inter-Integrated Circuit) communications.

The I2C command specification such as the 300 pin MSA (Multi-Source Agreement) is known for controlling a transponder.

Patent Literature 1 discloses a bridge device which implements a communication protocol layered on top of an I2C protocol. This device aims to support a great number of addresses while providing a certain degree of integrity of data traveling thereon.

Patent Literature 2 discloses a communication system in which a master device and a slave device perform I2C communications. In this system, the master device and the slave device are connected to each other with a notification line different from a communication line for detecting the occurrence of an anomaly, and at least one of the master device and the slave device includes: detection means for detecting anomaly occurring in the communication line; notification means for, when anomaly is detected, notifying the other module of the anomaly through the notification line; and recovery means for recovering the I2C communications when the anomaly is detected. The literature states that communication can be thereby recovered even when communication anomaly occurs.

### RELATED ART LITERATURE

Patent Literature 1 Japanese Patent Application Publication No. 2002-175269

Patent Literature 2 Japanese Patent Application Publication No. 2011-70282

Non-patent Literature 1 “300 PIN MSA-DOCUMENTS,” http://www.300pinmsa.org/html/documents.html

FIG. 9 and FIG. 10 are views for describing a problem in a conventional transponder 101. Upon receiving an I2C command from an I2C master 102 through an I2C circuit 111, the transponder 101 causes its controller 112 to judge whether or not the I2C command is executable and notify the I2C master 102 of the judgment result. The judgment is made with reference to an I2C command executability table 125 held by the controller 112. FIG. 10 shows an example of the I2C command executability table 125. The I2C command executability table 125 includes a column of CMD (hex) indicating the type of an I2C command and a column of CMD executability mode in compliance with the protected mode specified in the MSA.

In a conventional system, when the above notification is an error notification indicating that the command is not executable, the I2C master 102 sometimes erroneously recognizes this as a module failure even though the non-executable state is temporary. The non-executable state sometimes occurs temporarily in the course of a change in a communication status of the transponder 101 with a transmission (Tx) module 121 or with a reception (Rx) module (during initialization of the transponder 101, for example). Such erroneous recognition often occurs when the I2C master 102 builds a provisioning system and falls into a pattern of receiving the error notification repeatedly.

One of the causes of the above erroneous recognition is that the above executability notification does not include a Tx status and a Rx status which are information indicating communication statuses of the transponder 101 with the Tx module 121 or with a Rx module 122. Unlike the related art, an illustrative embodiment recognizes that, if the I2C master can receive the Tx status and the Rx status together with the executability judgment result from the transponder 101, the I2C master can interpret the executability judgment result in consideration of the Tx status and the Rx status.

Thus, an objective of an illustrative embodiment is to improve judgment accuracy of command executability.

However, an illustrative embodiment may achieve objectives other than those described above. Further, illustrative embodiments are not required to achieve the objectives described above, and an illustrative embodiment may not achieve any of the objectives described above.

A first aspect of an illustrative embodiment is a transponder connected to an I2C master, a transmission module, and a reception module, and configured to relay communications between the reception module and the transmission module in accordance with an I2C command issued by the I2C master, including: a transmission/reception status acquiring unit for periodically acquiring a current transmission status indicating a current communication status of the transmission module and a current reception status indicating a current communication status of the reception module; a transmission/reception status holding unit for holding the latest current transmission status and the latest current reception status; an executability table holding unit for holding a command executability table made by defining whether or not each of various kinds of the I2C command is executable in association with each type of the current transmission status and each type of the current reception status; an executability judging unit for judging whether or not the I2C command received from the I2C master is executable on the basis of the current transmission status and the current reception status held by the transmission/reception status holding unit and the command executability table; and a judgment result notifying unit for notifying the I2C master of the current transmission status and the current reception status held by the transmission/reception status holding unit together with a result of the judgment made by the executability judging unit.

A second aspect of an illustrative embodiment is a method for controlling a transponder which is connected to an I2C master, a transmission module, and a reception module, and configured to relay communications between the reception module and the transmission module in accordance with an I2C command issued by the I2C master, the method including: a transmission/reception status acquiring step of periodically acquiring a current transmission status indicating a current communication status of the transmission module and a current reception status indicating a current communication status of the reception module; a transmission/reception status holding step of holding the latest current transmission status and the latest current reception status; an executability judging step of judging whether or not the I2C command received from the I2C master is executable on the basis of the current transmission status and the current reception status held in the transmission/reception status holding step and a command executability table made by defining whether or not each of various kinds of the I2C command is executable in association with each type of the current transmission status and each type of the current reception status; and a judgment result notifying step of notifying the I2C master of the current transmission status and the current reception status held in the transmission/reception status holding step together with a result of the judgment made in the executability judging step.

A third aspect of an illustrative embodiment is a program for controlling a transponder causing a computer to execute the steps according to the second aspect.

According to an illustrative embodiment, the I2C master is notified by the transponder of the current transmission status and the current reception status together with the I2C command executability judgment result, and thereby can interpret the executability judgment result in consideration of the current transmission status and the current reception status. This enables improvement of command executability judgment accuracy in I2C communications.

### BRIEF DESCRIPTION OF THE DRAWINGS

FIG. 1 is a view showing a functional configuration of a transponder according to a first illustrative embodiment.

FIG. 2 is a view showing an example of a specific configuration of the transponder according to the first embodiment.

FIG. 3 is a view showing an example of a Tx status table according to the first embodiment.

FIG. 4 is a view showing an example of a Rx status table according to the first embodiment.

FIG. 5 is a view showing an example of an I2C command executability table according to the first embodiment.

FIG. 6 is a flowchart showing processing executed to acquire current Tx/Rx statuses in the first embodiment.

FIG. 7 is a flowchart showing processing executed when the transponder receives an I2C command in the first embodiment.

FIG. 8 is a flowchart showing processing executed when the transponder executes the I2C command in the first embodiment.

FIG. 9 is a view showing an example of a functional configuration of a conventional transponder.

FIG. 10 is a view showing an example of an I2C command executability table according to the transponder shown in FIG. 9.

### DETAILED DESCRIPTION OF ILLUSTRATIVE EMBODIMENTS

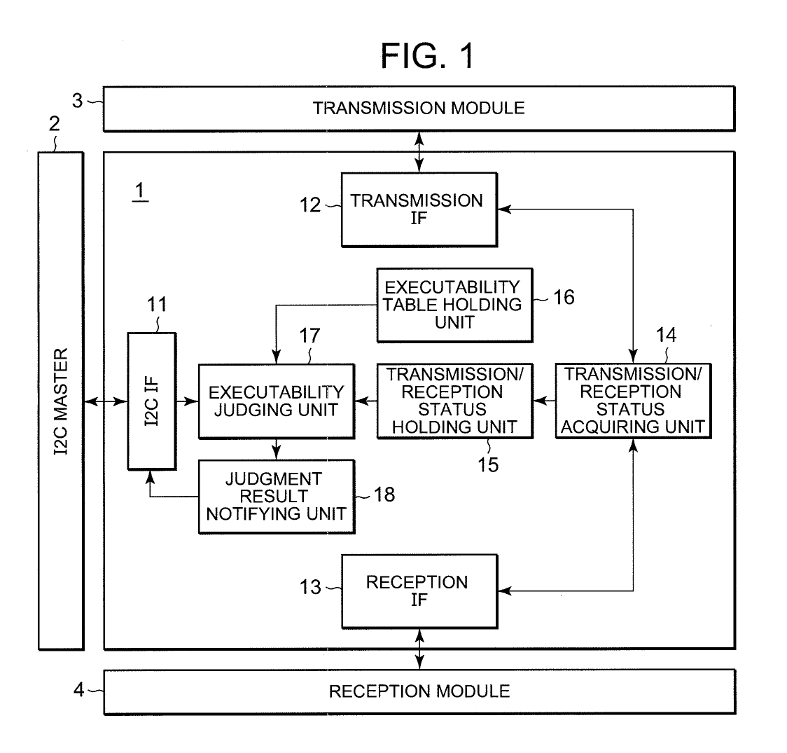

Hereinbelow, an illustrative embodiment is described with reference to the drawings. FIG. 1 shows a functional configuration of a transponder 1 according to a first illustrative embodiment. The transponder 1 is connected to an I2C master 2, a transmission module 3, and a reception module 4, and is configured to relay communications between the reception module 4 and the transmission module 3 in accordance with an I2C command outputted from the I2C master 2. The transponder 1 according to this illustrative embodiment has an I2C interface 11, a transmission interface 12, a reception interface 13, a transmission/reception status acquiring unit 14, a transmission/reception status holding unit 15, an executability table holding unit 16, an executability judging unit 17, and a judgment result notifying unit 18. For example, these function units are made up by allowing a microprocessor, a program to control the microprocessor, a memory, various logic circuits, transmission paths and the like to operate in concert with one another.

The transmission/reception status acquiring unit 14 is configured to periodically access the transmission interface 12 and the reception interface 13 to acquire a current transmission status (information) indicating a current communication status of the transmission module 3 and a current reception status indicating a current communication status of the reception module 4.

The transmission/reception status holding unit 15 is configured to hold (store) the latest current transmission status and current reception status acquired by the transmission/reception status acquiring unit 14.

The executability table holding unit 16 is configured to hold an I2C command executability table used for judging whether or not an I2C command outputted from the I2C master 2 is executable. The I2C command executability table is made by defining whether or not each of various I2C commands is executable in association with each type of a current transmission status and each type of a current reception status.

The executability judging unit 17 is configured to judge whether or not an I2C command received from the I2C master 2 is executable on the basis of a current transmission status and a current reception status held by the transmission/reception status holding unit 15 and the I2C command executability table.

The judgment result notifying unit 18 is configured to output, to the I2C master 2 through the I2C interface 11, the current transmission status and the current reception status (used for this judgment) held by the transmission/reception status holding unit 15 together with a result of judgment (on whether or not the I2C command is executable) made by the executability judging unit 17.

According to the above configuration, after outputting an I2C command, the I2C master 2 receives from the transponder 1 a current transmission status and a current reception status in addition to a result of judgment on whether or not the I2C command is executable. This allows the I2C master 2 to interpret the executability judgment result in consideration of the current transmission status and the current reception status. In other words, this makes it possible to prevent such a problem that an executability judgment result returned from the transponder 1 as non-executable is immediately judged as a module failure of the transponder 1.

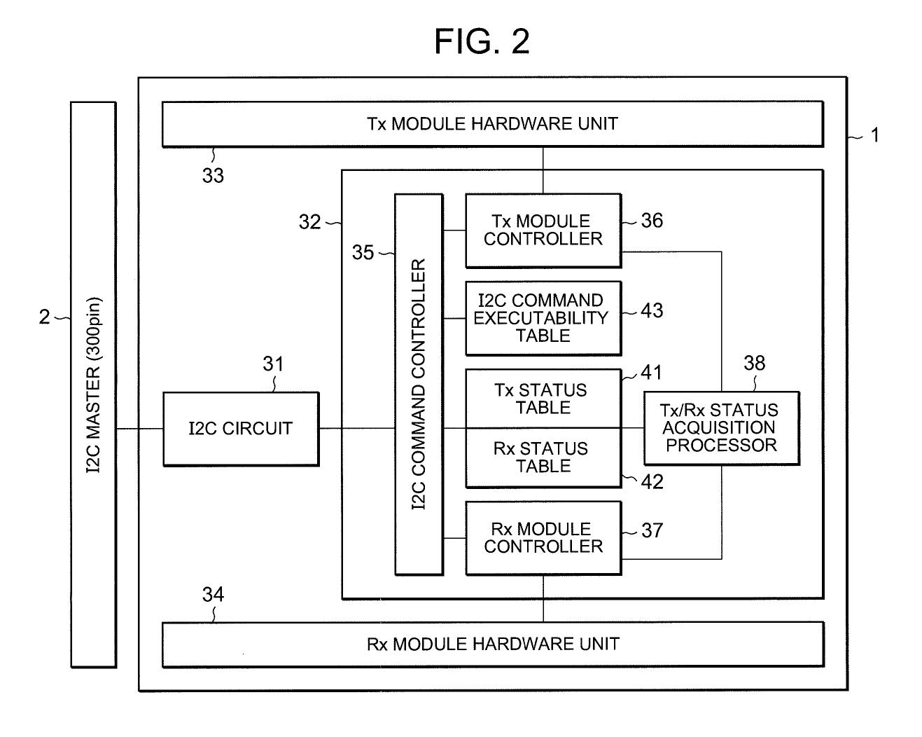

FIG. 2 shows an example of a more specific configuration of the transponder 1. The transponder 1 according to this example includes an I2C circuit 31 and a controller 32. The controller 32 includes an arithmetic processing unit such as a microprocessor as well as a memory such as an involatile memory. The controller 32 has an I2C command controller 35, a Tx module controller 36, a Rx module controller 37, a Tx/Rx status acquisition processor 38, a Tx status table 41, a Rx status table 42, and an I2C command executability table 43.

The I2C master 2 is connected to the I2C command controller 35 of the controller 32 through the I2C circuit 31. A Tx (transmission) module hardware unit 33 and a Rx (reception) module hardware unit 34 are plugged into connecters of the transponder 1, and connected to the Tx module controller 36 and the Rx module controller 37 of the controller 32 through transmission paths, respectively.

An I2C command outputted from the I2C master 2 is inputted into the I2C command controller 35 through the I2C circuit 31. An I2C command according to this example is compliant with the 300 pin MSA. The I2C command controller 35 is configured to control the Tx module controller 36 and the Rx module controller 37 in accordance with the I2C command. The Tx module controller 36 and the Rx module controller 37 are configured to control a Tx module and a Rx module, respectively.

The Tx/Rx status acquisition processor 38 is configured to periodically read signals from the Tx module controller 36 and the Rx module controller 37, and to create a current Tx status indicating a current communication status of the Tx module and a current Rx status indicating a current communication status of the Rx module. The current Tx status and current Rx status thus created are stored in the Tx status table 41 and the Rx status table 42. These tables 41 and 42 are constantly updated with the latest current Tx status and current Rx status.

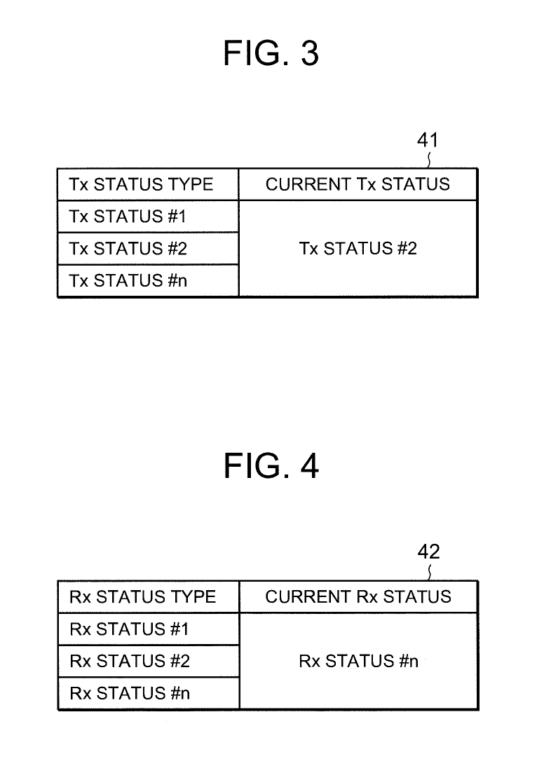

FIG. 3 shows an example of the Tx status table 41. FIG. 4 shows an example of the Rx status table 42. In the Tx status table 41, the left column: “Tx STATUS TYPE” indicates all the types of the communication status the Tx module can be in. The types vary according to the change of the Tx module. There are three types in this example, i.e., #1, #2, and #n. In the Tx status table 41, the right column: “CURRENT Tx STATUS” indicates a current Tx status acquired by the Tx/Rx status acquisition processor 38. The same applies to the Rx status table 42 shown in FIG. 4.

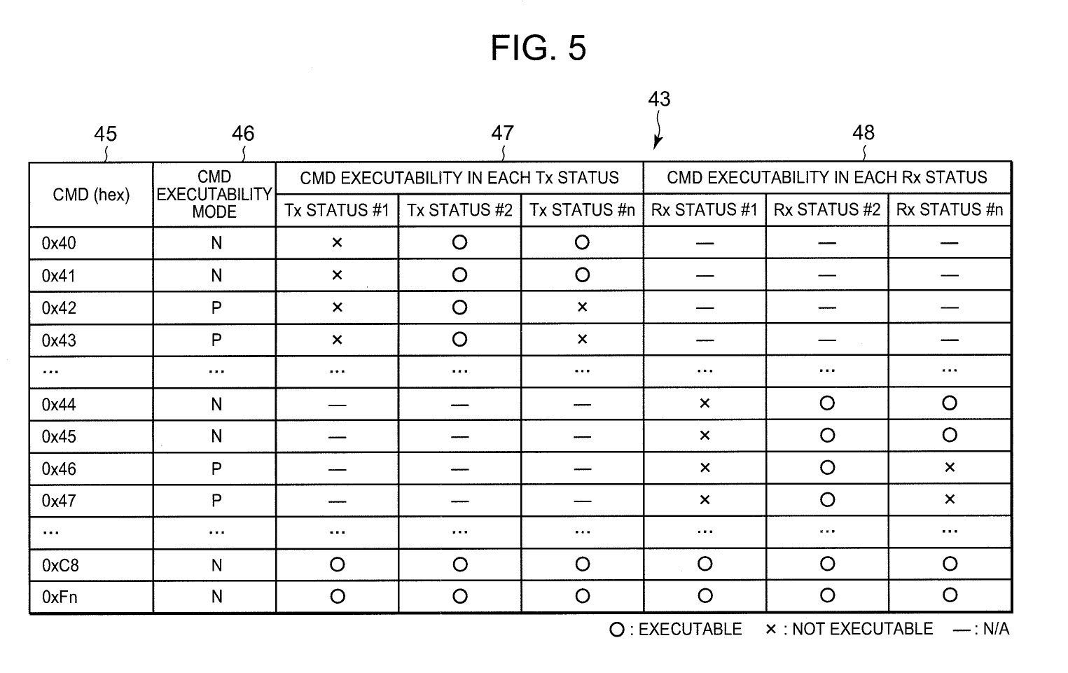

The I2C command executability table 43 is used for judging whether or not an I2C command outputted from the I2C master 2 is executable. FIG. 5 shows an example of the I2C command executability table 43. In FIG. 5, a “CMD (hex)” column 45 indicates the type of an I2C command. A “CMD executability mode” column 46 defines whether or not each I2C command is executable in compliance with the protected mode specified in the 300 pin MSA. A “CMD executability in each Tx status” column 47 defines whether or not the I2C command is executable in each type of the Tx status. A “CMD executability in each Rx status” column 48 defines whether or not the I2C command is executable in each type of the Rx status.

The I2C command controller 35 is configured to judge whether or not an I2C command is executable by applying the type of the I2C command, the type of a current Tx status, and the type of a current Rx status to the I2C command executability table 43, and to send the judgment result to the I2C master 2. The I2C command controller 35 is also configured to send the I2C master 2 the current Tx status and the current Rx status used for the judgment in addition to the I2C command executability judgment result.

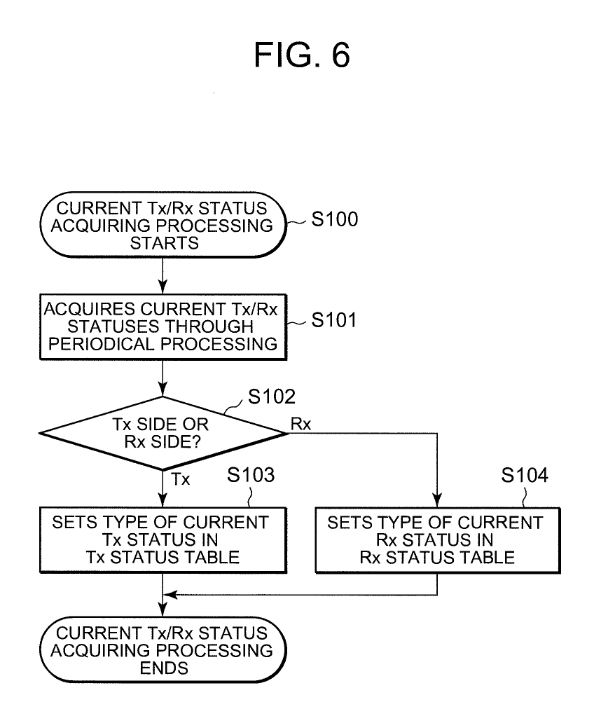

Hereinbelow, the operation of the transponder 1 is described. FIG. 6 shows processing executed to acquire current Tx/Rx statuses (S100). First, the Tx/Rx status acquisition processor 38 (see FIG. 2) acquires a current Tx status and a current Rx status from the Tx module controller 36 and the Rx module controller 37 through the periodical processing (S101). Next, the Tx/Rx status acquisition processor 38 judges whether or not the acquired information belongs to the Tx side or the Rx side (S102). The Tx/Rx status acquisition processor 38 sets the type of the current Tx status in the Tx status table 41 shown in FIG. 3 (S103) if the information belongs to the Tx side, and sets the type of the current Rx status in the Rx status table 42 shown in FIG. 4 (S104) if the information belongs to the Rx side.

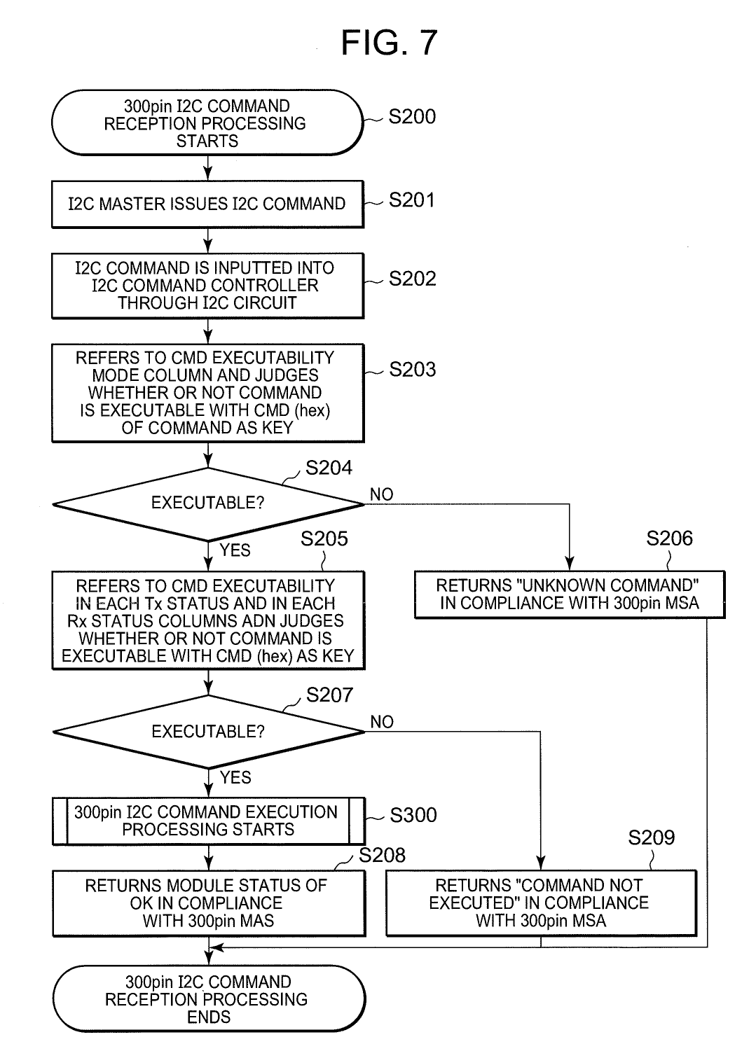

FIG. 7 shows processing executed when the transponder 1 receives an I2C command issued by the I2C master 2 and compliant with the 300 pin MSA (S200). First, upon issue of an I2C command from the I2C master 2 (S201), the I2C command is inputted into the I2C command controller 35 through the I2C circuit 31 (S202).

Subsequently, the I2C command controller 35 refers to the CMD executability mode column 46 of the I2C command executability table 43 shown in FIG. 5, and judges whether or not the command is executable with a CMD (hex) of the inputted I2C command as the key (S203). If judging in Step S203 that the command is not executable (S204: NO), the I2C command controller 35 returns “Unknown command” to the I2C master 2 in compliance with the 300 pin MSA (S206). On the other hand, if judging that the command is executable (S204: YES), the I2C command controller 35 refers to the CMD executability in each Tx status and in each Rx status columns 47 and 48 of the I2C command executability table 43, and judges whether or not the command is executable with the CMD (hex) as the key (S205).

If judging in Step S205 that the command is not executable (S207: NO), the I2C command controller 35 returns “Command not executed” to the I2C master 2 in compliance with the 300 pin MSA (S209). On the other hand, if judging that the command is executable (S207: YES), the I2C command controller 35 executes 300 pin I2C command execution processing (S300) described later, and then returns a module status of OK to the I2C master 2 in compliance with the 300 pin MSA (S208).

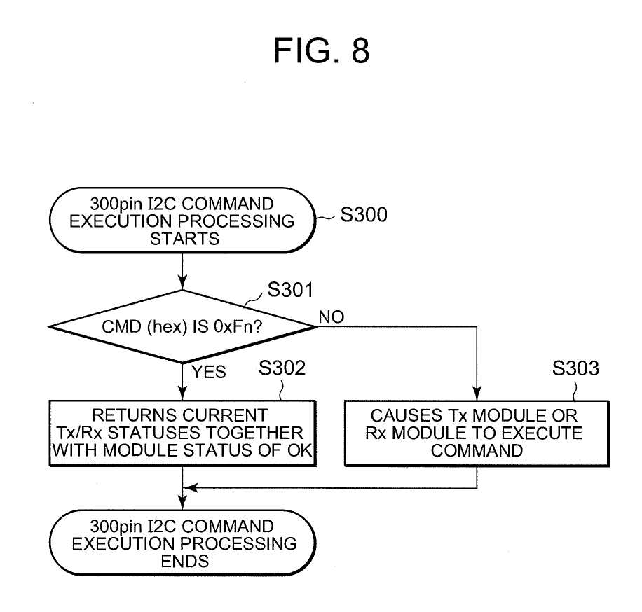

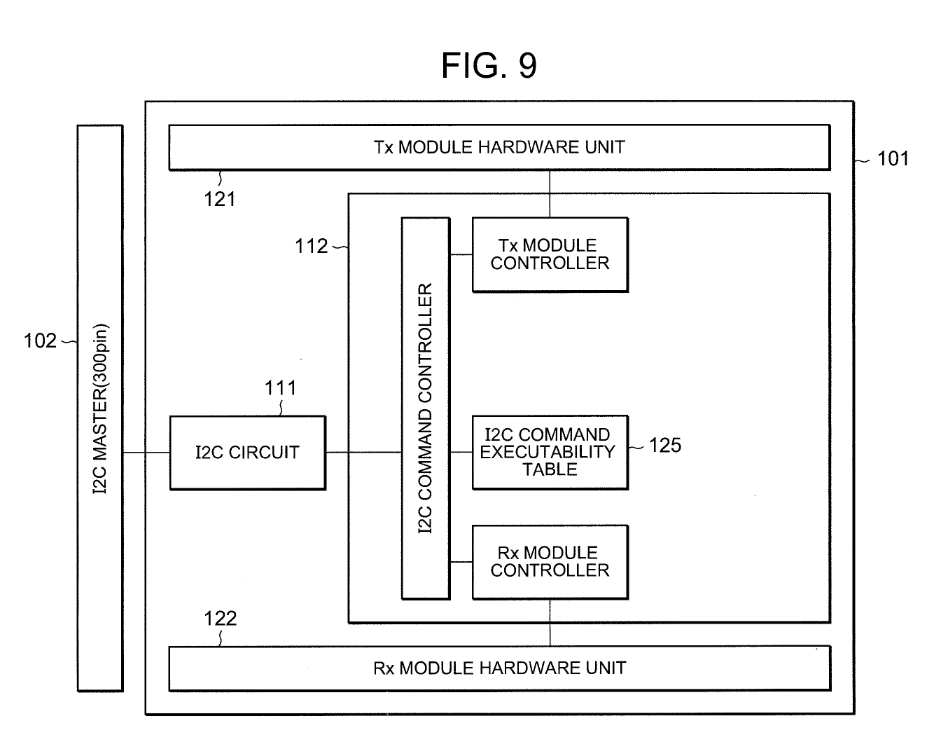

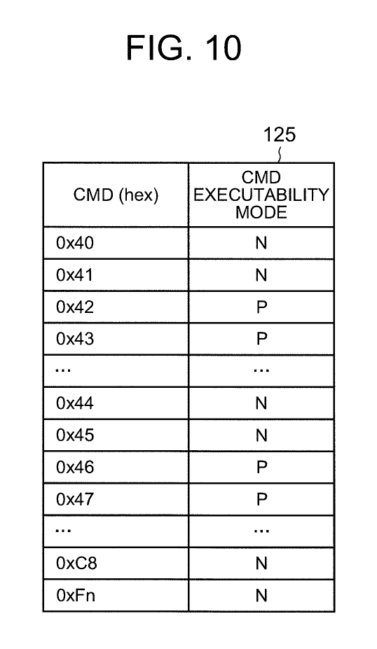

FIG. 8 shows processing executed when the transponder 1 executes a 300 pin I2C command outputted from the I2C master 2 (S300). First, the I2C command controller 35 judges whether or not a CMD (hex) of a command to be executed is 0xFn (S301). If the CMD (hex) is 0xFn (YES), the I2C command controller 35 returns, to the I2C master 2, current Tx/Rx statuses together with a module status of OK in compliance with the 300 pin MSA (S302). On the other hand, if the CMD (hex) is other than 0xFn (NO), the I2C command controller 35 causes the Tx module or the Rx module to execute the command (S303).

The transponder 1 described above notifies the I2C master 2 of the current Tx/Rx statuses while allocating 0xFn (where n is any of 0 to F) as a vendor-specific command ID specified in the 300 pin MSA 10G and 40G TRANSPONDER, for example. Thereby, the I2C master 2 can interpret an executability command while taking a module's prescribed specifications into consideration. This can prevent a module from being erroneously judged as being failed immediately when the I2C command is returned as an error.

Moreover, since the current Tx status and the current Rx status are independent from each other, the Tx module and the Rx module can be controlled asynchronously. This makes it possible to set the Tx part in an operation state whereas set the Rx part in a non-operation state, for example.

It should be noted that the present invention is not limited to the above illustrative embodiments but modification can be made as needed without deviating from the spirit and scope the invention as defined by the claims.

### Explanation of Reference Numerals

1 Transponder

I2C master

3 Transmission Module

4 Reception Module

11 I2C Interface

12 Transmission Interface

13 Reception Interface

14 Transmission/Reception Status Acquiring Unit

15 Transmission/Reception Status Holding unit

16 Executability Table Holding Unit

17 Executability Judging Unit

18 Judgment Result Notifying Unit

31 I2C circuit

32 Controller

33 Tx Module Hardware Unit

34 Rx Module Hardware Unit

35 I2C Command Controller

36 Tx Module Controller

37 Rx Module Controller

38 Tx/Rx Status Acquisition Processor

41 Tx Status Table

42 Rx Status Table

43 I2C Command Executability Table

What is claimed is:

1. A transponder connected to a master, a transmission module and a reception module, the transponder comprising:
a memory which stores a table indicating whether or not a command from the master is executable,
wherein the table comprises:
type information indicating a type of the command; and
first status information comprising at least one of:
a transmission status indicating a communication status of the transmission module; and
a reception status indicating a communication status of the reception module;
an acquiring unit that acquires second status information comprising at least one of:
a current transmission status indicating a current communication status of the transmission module; and
a current reception status indicating a current communication status of the reception module; and
a judging unit that judges, in response to a received command received from the master, whether or not the received command is executable using the table and the second status information.

2. The transponder according to claim 1, wherein the second status information is periodically acquired by the acquiring unit.

3. The transponder according to claim 1, further comprising a notifying unit that notifies the master of a result of the judgment made by the judging unit.

4. The transponder according to claim 3, wherein the notifying unit notifies the master of the second status information.

5. The transponder according to claim 4, wherein the notified second status information comprises information indicating that the received command is not executed if the judging unit judges that the received command is not executable.

6. The transponder according to claim 4, wherein the notified second status information comprises information indicating that the module status is ok if the judging unit judges that the received command is executable.

7. The transponder according to claim 1, wherein the received command is an I2C command which is according to the 300 pin Multi Source Agreement (MSA).

8. A method for controlling a transponder connected to a master, a transmission module and a reception module, the method comprising:
storing, at a memory, a table indicating whether or not a command from the master is executable,
wherein the table comprises:
type information indicating a type of the command; and
first status information comprising at least one of:
a transmission status indicating a communication status of the transmission module; and
a reception status indicating a communication status of the reception module;
acquiring second status information comprising at least one of:
a current transmission status indicating a current communication status of the transmission module; and
a current reception status indicating a current communication status of the reception module; and
judging, by at least one processor, in response to a received command received from the master, whether or not the received command is executable using the table and the second status information.

9. The method according to claim 8, wherein the second status information is periodically acquired.

10. The method according to claim 8, further comprising notifying the master of a result of the judging.

11. The method according to claim 10, wherein the result is notified to the master with the second status information.

12. The method according to claim 11, wherein the notified second status information comprises information indicating that the received command is not executed if the result of the judging indicates that the received command is not executable.

13. The method according to claim 11, wherein the notified second status information comprises information indicating that the module status is ok if the result of the judging indicates that the received command is executable.

14. The method for controlling a transponder according to claim 8, wherein the received command is an I2C command which is compliant with the 300 pin Multi Source Agreement (MSA).

15. A non-transitory computer readable medium embodying instructions for controlling a device to implement a method for controlling a transponder connected to a master, the method comprising:
storing, at a memory, a table indicating whether or not a command from the master is executable,
wherein the table comprises:
type information indicating a type of the command; and
first status information comprising at least one of:
a transmission status indicating a communication status of the transmission module; and
a reception status indicating a communication status of the reception module;
acquiring second status information comprising at least one of:
a current transmission status indicating a current communication status of the transmission module; and
a current reception status indicating a current communication status of the reception module; and
judging, by at least one processor, in response to a received command received from the master, whether or not the received command is executable using the table and the second status information.

16. The computer readable medium according to claim 15, wherein the second status information is periodically acquired.

17. The computer readable medium according to claim 15, wherein the method further comprises notifying the master of a result of the judging.

18. The computer readable medium according to claim 17, wherein the result is notified to the master with the second status information.

19. The computer readable medium according to claim 18, wherein the notified second status information comprises information indicating that the received command is not executed if the result of the judging indicates that the received command is not executable.

20. The computer readable medium according to claim 18, wherein the notified second status information comprises information indicating that the module status is ok if the result of the judging indicates that the received command is executable.

21. The transponder according to claim 1, further comprising a holding unit that holds the second status information acquired by the acquiring unit,
wherein the judging unit uses the second status information held by the holding unit.

22. The method according to claim 8, further comprising holding the acquired second status information,
wherein the judging uses the held second status information.

23. The computer readable medium according to claim 15, wherein the method further comprises holding the acquired second status information, and
wherein the judging uses the held second status information.
